(19) United States
(12) Patent Application Publication
(10) Pub. No.: US 2021/0216576 A1
(43) Pub. Date: Jul. 15, 2021

(54) SYSTEMS AND METHODS FOR PROVIDING ANSWERS TO A QUERY

(71) Applicant: RELX Inc., Miamisburg, OH (US)

(72) Inventors: Bert Staub, Tipp City, OH (US); Sanjay Sharma, Raleigh, NC (US); Soha Khazaeli, Cary, NC (US); Dhruv Sakalley, Morrisville, NC (US); Chad Morris, Durham, NC (US); Sunny Chiu-Webster, South Croydon (GB); Shyjee Mathai, Miamisburg, OH (US); Janardhana Punuru, Cary, NC (US); Sachin Kumar, Raleigh, NC (US); Kishore Ethiraj, Miamisburg, OH (US); Aaron James Pohl, Smithfield, NC (US)

(73) Assignee: RELX Inc., Miamisburg, OH (US)

(21) Appl. No.: 17/148,905

(22) Filed: Jan. 14, 2021

Related U.S. Application Data
(60) Provisional application No. 62/960,749, filed on Jan. 14, 2020.
(60) Provisional application No. 63/046,144, filed on Jun. 30, 2020.

(51) Int. Cl. G06F 16/33; G06F 16/338; G06F 16/332; G06F 40/284

(52) U.S. Cl. CPC G06F 16/3346; G06F 40/284; G06F 16/3328; G06F 16/338

(57) ABSTRACT

Systems and methods for open domain question-answering are disclosed. In one embodiment, a method of providing answers to a question includes retrieving, by a computing device, a plurality of passages relevant to a search query generating a plurality of question-passage pairs, wherein each question-passage pair includes the search query and an individual passage of the plurality of passages, and determining, using a computer model, a probability that a passage of each question-passage pair of at least some of the plurality of question-passage pairs is an answer to a question posed by the search query. The method also includes displaying, on an electronic display, a selected passage of a question-passage pair having a highest probability that the passage is the answer to the question posed by the search query.

### CROSS-REFERENCE TO RELATED APPLICATIONS

This application claims the benefit of priority under 35 U.S.C. § 119 to U.S. Provisional Application No. 62/960,749, filed on Jan. 14, 2020 and entitled “LEGAL DOMAIN RETRIEVAL-BASED QUESTION ANSWERING WITH LEGAL BERT,” and Provisional Application No. 63/046,144 filed on Jun. 30, 2020 and entitled “LEGAL OPEN QUESTION ANSWERING SYSTEMS AND METHODS,” the contents of which are hereby incorporated by reference in their entireties.

### BACKGROUND

Once a legal researcher has a case in the discovery process, she has a set of legal questions to be investigated. She uses the answers to develop different documents for the phases of the case such as writing briefs and motions. The researcher might know or not know the answer of each question in her list. Regardless of her knowledge about the specific legal issue, the legal researcher looks for the answer again, since she quotes the answer in the document that is being developed. In addition, she might find more recent cases or better cases considering the fact pattern and the jurisdictions. Stare decisis is the doctrine of legal precedent that dictates that a later case can be decided based on earlier cases with similar issues and/or facts in the proper jurisdiction. This doctrine enforces the use of citations for each noteworthy legal statement.

Legal question answering should not target just factoid questions. Factoid questions can only cover a low percentage of the lawyer's questions. Analysis of lawyers' questions has shown that most of them are descriptive questions. Even in “What” question cases or yes/no questions, the answers are not a short span of text. They are multi-sentence legal statements that usually include reasoning and citations. These statements should be further studied to be chosen as authoritative legal statement.

In the legal domain, sometimes there is no unique answer. In many cases, the answer is contradictory from jurisdiction to jurisdiction. The answer in a developing area of law could change as time passes. The answer could be different if you look at it from different angles. These complexities are inherited from legal domain and the relationships between people, society, rules and government.

Open domain question answering is a challenging and demanding area. An open domain question answering system answers varying and free format questions using a large corpus of passages/documents. In these systems, there are no preselected passages associated with individual questions.

Current systems may present answers to a researcher that are not the best possible answers. For example, a passage may be semantically similar to a question that is posed but be complete off-point and irrelevant. Such answers are off-putting to researchers and may cause researchers to not trust the question answering system.

Alternative methods for selecting and presenting optimal answers to questions using open domain questioning are desired.

### SUMMARY

Embodiments of the present disclosure are directed to open domain questioning methods and systems that include a two-step architecture to provide the best re-ranked passages from lexical and semantical retrieved passages. More specifically, in a first information retrieval step, a first set of passages are retrieved using lexical and semantical search systems. Next, in an answer finder step, the passages are evaluated to re-rank the passages and display the best passages as the answers to a query.

In one embodiment, a method of providing answers to a question includes retrieving, by a computing device, a plurality of passages relevant to a search query generating a plurality of question-passage pairs, wherein each question-passage pair includes the search query and an individual passage of the plurality of passages, and determining, using a computer model, a probability that a passage of each question-passage pair of at least some of the plurality of question-passage pairs is an answer to a question posed by the search query. The method also includes displaying, on an electronic display, a selected passage of a question-passage pair having a highest probability that the passage is the answer to the question posed by the search query.

In another embodiment, a system for providing answers to a question includes one or more processors, and a non-transitory computer-readable medium storing computer-readable instructions that, when executed by the one or more processors, cause the one or more processors to retrieve a plurality of passages relevant to a search query, and to generate a plurality of question-passage pairs, wherein each question-passage pair includes the search query and an individual passage of the plurality of passages. The computer-readable instructions further cause the one or more processors to determine, using a computer model, a probability that a passage of each question-passage pair of at least some of the plurality of question-passage pairs is an answer to a question posed by the search query, and to display, on an electronic display, a selected passage of a question-passage pair having a highest probability that the passage is the answer to the question posed by the search query.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE DRAWINGS

FIG. 1 is a schematic illustration of an example open domain questioning system according to one or more embodiments described and illustrated herein;

FIG. 2 is a further schematic illustration of the example open domain questioning system of FIG. 1 according to one or more embodiments described and illustrated herein;

FIG. 3 is a further schematic illustration of the example open domain questioning system of FIG. 1 according to one or more embodiments described and illustrated herein;

FIG. 4 is a schematic illustration of an example offline system of an example open domain questioning system according to one or more embodiments described and illustrated herein;

FIG. 5 is a schematic illustration of an example BERT sequence binary classifier of an example answer finder module according to one or more embodiments described and illustrated herein;

FIG. 6 is a schematic illustration of an example graphical user interface of a front-end application according to one or more embodiments described and illustrated herein;

FIG. 7 is a graph showing the average probabilities of being a good answer for different retrieval and ranking methods according to one or more embodiments described and illustrated herein;

FIG. 8 is a graph showing correlation between the answer finder module's probabilities and subject matter expert's scores according to one or more embodiments described and illustrated herein; and

FIG. 9 is a schematic illustration of an example computing device for an open domain questioning system according to one or more embodiments described and illustrated herein.

### DETAILED DESCRIPTION

Embodiments of the present disclosure are directed to open domain questioning methods and systems that find and display an optimum answer in response to a user's natural language query. A user may enter a natural language query into a text box of a graphical user interface, for example. As a non-limiting example, the user may type the natural language question “Is an airline liable for its pilot's negligence?” The user will expect answers that are relevant and helpful to her research.

In embodiments, the system uses an information retrieval process to retrieve passages that potentially answer the question. These passages may be ranked by relevance, for example. Some or all of these passages are then provided to an answer finder module that re-ranks the passages based on the probability of each passage being a correct answer to the natural language query. One or more of the passages are selected as the answer(s) for display to the user in an electronic display. The answer finder significantly reduces the amount of time that a user searches for an answer to her question, and also reduces the amount of computing time and power because fewer queries need to be submitted for the user to find the correct answer to the question.

Various embodiments of open domain questioning systems and methods are described in detail below.

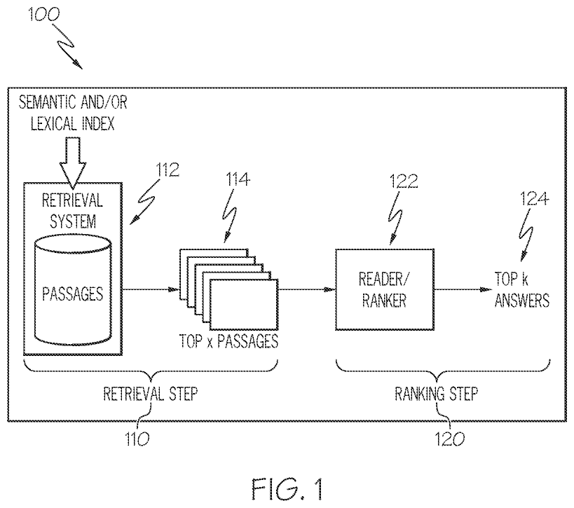

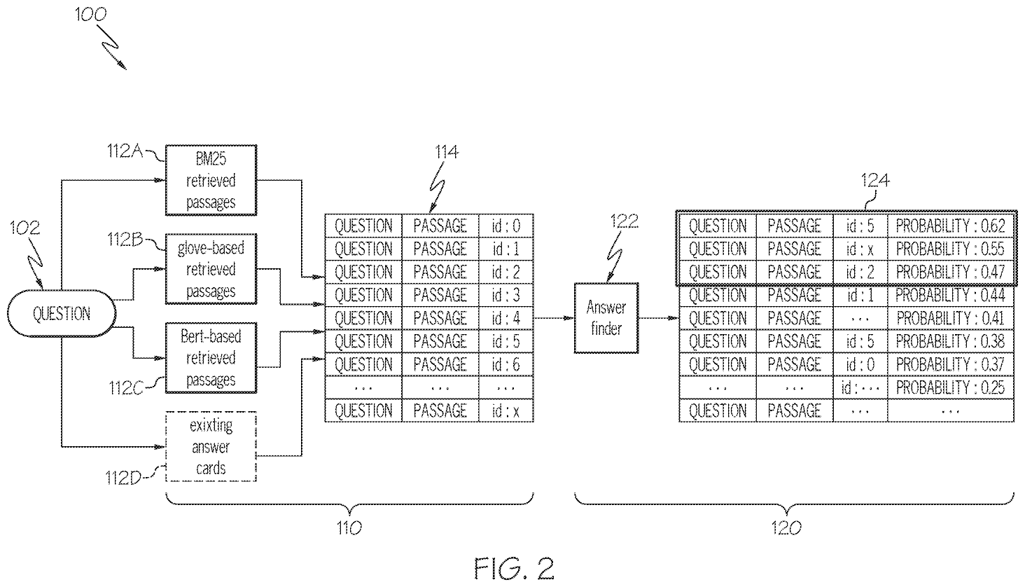

Referring now to FIG. 1, an example open domain questioning system 100 is schematically illustrated. The system 100 is configured to perform an initial information retrieval step 110 to retrieve passages, and a subsequent ranking step 120 to determine one or more optimal answers for display to a user. The system 100 includes one or more information retrieval systems 112 configured to retrieve passages that may potentially be answers to a received natural language query. The one or more information retrieval systems 112 scan a document corpus to retrieve the top passage 114. FIG. 2 illustrates the example open domain questioning system 100 of FIG. 1 in greater detail. In the non-limiting example of FIG. 2, a question 102 (e.g., in the form of a query) is provided to the one or more information retrieval systems 112, which in this case includes a BM25 search system 112A, a GloVe search system 112B, and a BERT (bidirectional encoder representations from transformers) search system 112C. It should be understood that more, less, and/or different search systems may be utilized. In some embodiments, each of these search systems retrieve passages that are then paired with the question 102 that is presented (i.e., the natural language query).

Referring to both FIGS. 1 and 2, the question-passage pairs, which may each be assigned with an identification number, are provided to the answer finder 122, which determines for each question-passage pair a probability that the passage is an answer to the question. The top ranked passages are selected as answers 124 and presented to the user in an electronic display.

Information retrieval systems may depend on vector spaces. Starting from the introduction of TF-IDF for information retrieval, a vast array of approaches like BM25 and variants such as BM25F and LambdaRank have been developed. A Query By Document method (QBD), also called as More Like This, is common in search platforms. Although different BM25 methods have been proven to bring highly relevant documents, such lexical search systems are very sensitive to the query language. If a user does not include the same word that is used within the content of the corpus and within the index of the content, she can get disappointing search results. Therefore, retrieval systems optimize the search by adding synonyms to alleviate this problem.

The other approach to reduce the lexical sensitivity is to add a semantic index. Each query or document is represented with a compressed vector based on a pre-trained embedding model. For example, Word2vec models are pretrained based on predicting the center words based on the other words in the fixed window of the adjacent words or the reverse. Another popular word embedding approach called GloVe (Global Vectors) is based on ratios of word co-occurrence probabilities. These word embedding methods have just one vector for each word even if the word is an ambiguous word. To solve word ambiguities, ELMo (Embeddings from Language Models) represents the meaning of a word in its context.

Contextual pre-trained models using multi-stacked transformers such as BERT also provide contextual vectors for words or entire input texts (with the limit of 512 tokens); however BERT as a language model is not trained on sentence similarity, which is more suitable for an information retrieval task. Sentence-BERT using the BERT architecture provides sentence embedding that is fine-tuned for sentence similarity using a Siamese network. Other search systems may improve retrieval with the co-learning of the retriever and the reader from question-passage pairs, or pre-training the language representation on a retrieval task.

In embodiments of the present disclosure, starting from information retrieval, each document is a passage. That is, the corpus is made up of passages that are a combination of Headnotes and RFCs (Reason For Citing). As a non-limiting example, a headnote is a point of law expressed in a case written by a judge which is picked and sometimes slightly edited by editors as a general point of law. An RFC is a passage of a case which contains sentences near a document citation (such as a court case citation) that suggest the Reason(s) For Citing (RFC). Existence of a citation in a paragraph is the indicator of legal significance of the paragraph. The corpus may be made up of other content types as well, such as statutes, legal treatises, and the like.

The lexical search retrieval system part may be performed by BM25 (more like this) 112A. The alternative approaches for semantic information retrieval may be retrieving similar passages using GloVe embedding 112B and Siamese BERT embedding 112C.

Compared to the simple word2vec model, GloVe embeddings are built based on co-occurrence matrix of words. Because of the need for a covariance matrix, it takes an extra pass of the data. However, since GloVe takes global occurrence into account, it gives better representation of the vocabulary compared to the word2vec algorithm.

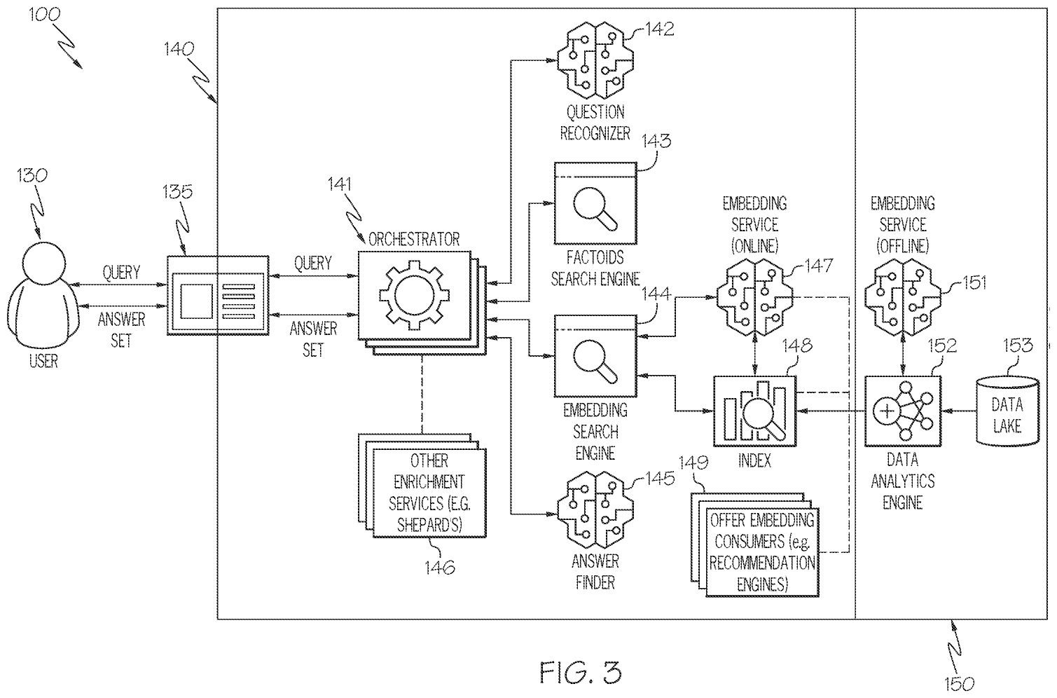

FIG. 3 schematically illustrates the example open domain questioning system 100 in greater detail. Particularly, FIG. 3 illustrates the system 100 in terms of an online system 140 and an offline system 150. A user 130 interacts with the open domain questioning system 100 by a front-end application 135, such as a webpage or a stand-alone application. The user may enter a search query, such as a natural language search query, into a text field of the front-end application 135, and receive an answer set that is displayed in the front-end application 135 on an electronic display.

The offline system 150 receives, prepares and stores data for search and retrieval. Generally, the offline system comprises an offline embeddings service 151, a data analytics engine 152, and a data storage system 153 (e.g., a data lake). The data storage system 153 may store any data, such as documents (e.g., legal documents, such as legal opinions), passages, sentences, snippets, and the like. The data analytics engine 152 coordinates tasks such as document ingestion, data processing, embedding coordination, and indexing.

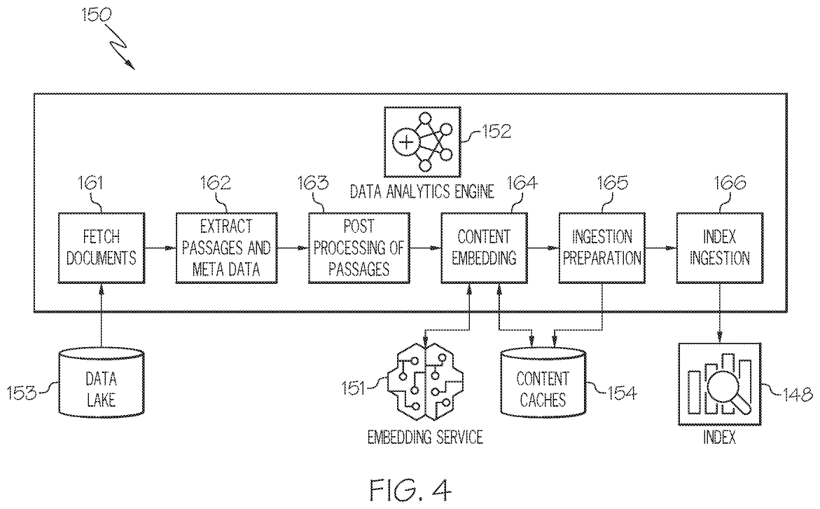

FIG. 4 illustrates the offline system 150 and the data analytics engine 152 in greater detail. The data analytics engine 152 may be programmed by any means. As a non-limiting example, the data analytics engine 152 may be configured as an Apache Spark™ cluster having a number of functionalities. FIG. 4 illustrates non-limiting functionalities of the data analytics engine 152. It should be understood that more or fewer functionalities may be performed.

The data analytics engine 152 is programmed to retrieve documents from the data storage system 153 at block 161, which may be configured as a data lake, which stores a plurality of documents. In the legal context, the data storage system 153 may store legal opinions, legal briefs, motions, statutes, and the like. However, although embodiments of the present disclosure are described in the context of the legal field, embodiments are not limited thereto. Embodiments may be utilized for any type of document corpus (e.g., engineering, medicine, astronomy, and the like).

At block 162, paragraphs, passages and metadata are extracted from the retrieved documents. Other information may also be extracted. As a non-limiting example, the passages may be headnotes and RFCs. Information regarding extracting RFCs from documents is found in U.S. Pat. No. 6,856,988, which is hereby incorporated by reference in its entirety. Metadata may include, but is not limited to, topical classification, timeline, and jurisdiction information.

In some embodiments, the data analytics engine 152 may perform post processing of the extracted information, such as paragraphs and passages, at block 163. In this step, the extracted information may be cleaned and/or removed as needed. Removal of passages reduces the size of the resulting index and also reduces noise. For example, exact duplicates, or passages found without other larger passages, may be removed. Citations and non-alpha characters may also be removed. As another example, semantic similarity of passages may be performed, and passages having a semantic similarity above a threshold to another passage may be removed.

The extracted information may also be enhanced, such as by list rollup (i.e., a concatenation of a bulleted list into a single passage to form a coherent answer passage), geography mapping, date validations (e.g., stamped dates on documents that are used to resolve a date that will be displayed to the user), and corpus aggregations. Geography mapping refers to using contextual clues within a passage (e.g., a state) to infer a jurisdiction such that the passage may be more contextually relevant. Further, information where a passage came from can be used to infer jurisdiction information. With respect to corpus aggregations, passages are processed first starting as documents and then separated into passages. Additional processing may occur across the corpus to generate additional metadata that can be associated with the passage for purposes of display or ranking. Non-limiting examples of this include citation counts and similarity measures to identify similar passages.

After post-processing, the data analytics engine 152 is configured to coordinate content embedding of the passages at block 164. Particularly, the data analytics engine 152 interfaces with embedding services 151, such as GloVe and BERT embedding services. Additional information regarding the GloVe and BERT embedding processes are described below with respect to the Example. The embedding service may be performed by offline hardware or online hardware. The embeddings of the passages are used by the online system 140 to find passages relevant to a user query.

As a non-limiting example, the embeddings service may employ a pretrained BERT language model that is trained on a legal corpus. This Legal BERT is trained on hundreds of millions of legal examples, such as case law headnotes and RFCs and secondary sources, such as treatises. In this example, the Legal BERT used by the offline system 150 comprises highly optimized, dense vector indices generated from an entire corpus for serving the purpose of performing similarity searches with respect to queries of the online process. The data analytics engine 152 is configured to convert the legal content into embeddings using the Legal BERT embedding service 151.

In some embodiments, the embeddings may be cached in a data store 154. The smaller the unit of text used for representing the vector increases the likelihood that the text will be identical to an existing vector representation. The data store 154 of the embeddings provide the ability to reuse existing vectors to reduce costs, time to embed, and (if being utilized) reduce utilization of online embedding services to avoid end user disruption.

At block 165, embeddings at block 164 are combined with metadata extractions. The text that is embedded is stripped of metadata during the embedding process. Only text that does not have a vector representation is embedded. This embedding is then stored back into the cache. The resulting vectors are joined back to the metadata in preparation for injection into an index.

At block 166, the data prepared at block 164 are ingested into an index 148, which may be done using rate limiting to maintain a healthy and responsive search engine. As a non-limiting example, the index 148 may be an ElasticSearch index capable of being searched by the ElasticSearch search engine. It should be understood that ElasticSearch is used here merely as an example, and that embodiments are not limited to any particular search engine or indices.

The index 148 is a content repository for the embeddings of the passages (i.e., the vectors of the passages), as well as metadata and the underlying text of the embeddings. The metadata is provided in additional fields of the index that may be used for adjusting the scoring, ranking, and filtering during the search and retrieval stages. The index 148 may include multiple indices, with a separate index for each content type (e.g., legal cases, statutes, treatises, etc.). As a non-limiting example, there may be over 100 million passages for the case law content type. In some embodiments, embeddings (i.e., vectors) may be stored in one index, the passage text in another index, and the metadata and another index. In other embodiments, embeddings, metadata, and text is stored in a single index.

As a non-limiting example, the index 148 may be configured as a Hierarchical Navigable Small World (HNSW), which is a fully graph-based incremental k-ANN structure that relaxes the condition of the exact search by allowing a small number of errors with better logarithmic complexity scaling as compared to other versions of k-ANN algorithms. In some embodiments, a non-metric space library (NMSLIB) and alternatively Fiass library may be employed with the HNSW algorithm. Both NMSLIB and Fiass are an efficient and extendable implementation of the HNSW algorithm. Using NMSLIB or Fiass, various highly optimized dense vector indices for a range of embeddings and similarity spaces may be generated, which are used for similarity searching with question embedding/encoding to find the nearest neighbors.

Thus, the offline system 150 produces an index 148 that includes embeddings and metadata of passages of the documents stored in the data storage system 153. The index 148 may be continuously updated as new documents are added to the data storage system 153. For example, new legal opinions are continuously being issued and added to the data storage system 153.

Referring once again to FIG. 3, the online system 140 will now be described. As stated above, a user 130 submits a query to the system 100 by a front-end application 135. The query is passed from the front-end application 135 to an orchestrator module 141. It should be understood that embodiments may not include an orchestrator module 141, and/or may include different online system modules that perform the functionalities described herein.

In embodiments, the orchestrator module 141 is the primary controller of the open domain questioning system 100. It coordinates questions recognition, coordinates the query engagement decision, preprocesses the question, initiates search and retrieve workflows, aggregates search results from disparate sources, initiates the answer finder (i.e., the re-ranker) workflow, and post-processes the results.

Upon receipt of the query, the orchestrator module 141 passes the query to a question recognizer module 142 that includes a question classifier function, an intent recognition function, and a jurisdiction/court recognition function. It should be understood that embodiments operating outside of the legal context will not have a jurisdiction/court recognition function. The question recognizer module 142 may have more or fewer functions depending on the application.

The question classifier function of the question recognizer module 142 determines the type of query. Query types include, but are not limited to, a natural language question (i.e., an explicit, well-formed natural language question), a natural language query (i.e., a natural language query that is not phrased as a question), a Boolean query, a single document retrieval query, and a segment search query. Thus, the question recognizer module 142 recognizes the type of query that has been inputted into the system 100. Question classification prevents un-answerable queries from putting excess load on the system 100. Question classifier recognizes explicit and implicit questions from the rest of the queries. These explicit and implicit questions will be passed on to the system to provide answers.

The intent recognition function of the question recognizer module 142 predicts the intent of the user with respect to the type of information she expects to see as an answer. Example types of information include, but are not limited to, dictionary factoids (e.g., definitions, doctrines), case law factoids (e.g., elements, statute of limitations, burden of proof, standards of review), and entities (e.g., judges, experts). Particularly, target term identification is done for definitions, doctrines, elements, statute of limitations, burden of proof, standards of review, judges, and experts queries. The target term identification may be performed by statistical models and also deep learning methods.

Inline jurisdiction recognition may be done with statistical models, such as conditional random fields. When a jurisdiction recognized in a query, it may be removed from query, but then later add it as filter.

The query engagement function of the question recognizer module 142 filters out queries that are not suitable for the answer finder module. Non-suitable queries are not routed to the answer finder module. Queries that are suitable and handled by the answer finder are natural language questions and natural language queries with the intent known. Queries that are not suitable and not handled by the answer finder are natural language queries with the intent unknown and any other queries. The query engagement function ensures that query engagement is performed by the appropriate search engine, and prevents un-answerable/poor quality answers for queries from putting excess load on the system 100.

Still referring to FIG. 3, the orchestrator module 141 also coordinates the search and retrieval process. Multiple search engines may be utilized in searching for passages. For example both lexical and semantic search engines may be used. In the illustrated embodiment, the orchestrator module 141 coordinates with a factoids search engine 143 and an embedding search engine 144.

The main function of the factoids search engine is to perform lexical searches. As non-limiting examples, the lexical searches may be performed by using a key index look up, or by using DynamoDB provided by Amazon Web Services. The DynamoDB table is a key value pair, where the key corresponds to a target term such as “mail fraud” and the value corresponds to elements relating to the mined answer relating to the key value. For instance if the factoid intent is statute of limitations and the target term is “main fraud” then the answer card stored as the value will have associated content.

The factoids search engine 143 is configured to retrieve short factoid answers such as dictionary, case law, and entity factoids. In some embodiments, the factoids search engine is configured to retrieve prepared/curated factoid answers to questions. Non-limiting examples of dictionaries for the legal context include Balentine, Bouvier Law Dictionary, and The Law Dictionary. Factoid example for the case law content type include “elements of,” “statutes of limitations,” “burden of proof,” and “standard of review” as curated by subject matter experts. The factoids search engine 143 may also be configured to filter the results, such as by jurisdiction or court.

The online embeddings service 147, which may be used by online and offline components, generates a vector (i.e., embeddings) representation of the input text. The online embeddings service 147 may generate a vector for the input query, for example. The online embeddings service 147 may create any type of embeddings. As non-limiting example, the online embeddings service 147 provide BERT embeddings (e.g., BERT-as-a-Service) and/or GloVe (e.g., GloVe-as-a-Service). It is noted that, although offline embeddings service 151 and online embeddings service 147 are illustrated as separate components in FIG. 3, they may share the same logic and be a single component. As a non-limiting example, they may be separate if there is additional transformation and to avoid additional load on an asset that is being used by a customer. Further, data embedding requirements may be different (e.g., a single query may be processed at runtime/online versus needing to process 100+ million passages as fast as possible offline).

As stated above, the Legal BERT pretrained model may be utilized. Using Legal BERT, when a query comes in, a dimensional representation of the query is generated. As a non-limiting example, the representation of the query may have 1024 dimensions. This representation will be used for the similarity search with content embeddings, indexed in the index 148 (e.g., NMSLIB index), to retrieve passages that are potential answers to the query.

The embedding service 147 and the index 148 may be accessed by other embedding consumers 149, which can be used for a number of tasks, such as features for search algorithms and recommendation engines. The recommendation engines, e.g. Brief Analysis case law recommendations, may embed the data (brief passages) using the online embedding service 147 and then use the index 148 to perform a search to generate content to recommendations.

The embedding search engine 144 may be configured as any embedding search engine. The embedding search engine 144 allows for open question-answer searching capability by lexical and/or semantic search and retrieve functionally. As a non-limiting example, the embedding search engine 144 is an embeddings question answering service (EQAS).

The EQAS a search engine that employs embeddings to perform searching functionalities. EQAS uses both an embeddings representation of the user query to perform semantic search as well as the plain text representation of the user query to perform traditional lexical search. Both types of searches are run simultaneously in parallel. The two returned search results are combined into one single answer set. As each search method may sometimes have some overlap (common answers), the embedding search engine 144 also performs a deduping operation so that the single answer set consists of only unique answers.

The main functions of the embedding search engine 144 is to perform semantic (or dense vector) searching and lexical (or sparse vector) searching. For semantic searching, the embedding search engine 144 may use a searching service, such as an online embeddings service 147, or run an Amazon Web Services ElasticSearch k-nearest-neighbor (k-NN), against the index 148. The embedding search engine 144 uses an embeddings service 147 to first convert the user query (plain text) to an embeddings representation. Next, the embedding search engine 144 runs a k-NN search against the ElasticSearch index 148. For lexical searching, embodiments may run “more like this” queries against the index 148.

The semantic searching finds passages that are semantically similar to the query. Two non-limiting similarity measures for k-NN comparison with embedding vectors in the index 148 include:

### Cosine Similarity:

$$cosinesimil = \frac{{\sum }_{i = 1}^{n} {x}_{i} {y}_{i}}{\sqrt{{\sum }_{i = 1}^{n} {x}_{i}^{2}} \sqrt{{\sum }_{i}^{n} {y}_{i}^{2}}} ,$$

where x and y are embedding vectors of dimension n.
Euclidean L2 similarity:

$$l 2 = \sqrt{{\sum }_{i = 1}^{n} {\vert {x}_{i} - {y}_{i} \vert}^{2}}$$

where x and y are embedding vectors of dimension n.

Any other vector similarity measures can be used in place of these frequently used measures to achieve the same objectives at varying levels of accuracy and desired behavior.

The index 148 may also perform filtering of the results. The semantic search and lexical search query constructed by the embedding search engine 144 may optionally include filter sub-constructs if indicated by the user. For example, if the user specified one or more jurisdictions (e.g., a state or province) explicitly within which the search is to be performed, then appropriate filter sub-constructs are passed to the ElasticSearch index 148. Other filter types we support are court, timeline, legal topic, etc.

The index 148 may also perform boosting of the results. More particularly, answer passages in the search results that are from higher courts (whose opinions/rulings have higher authority) and passages that are from more recent court cases (e.g., cases from last the 10 or 15 years) are requested by the embedding search engine 144 to be given a boost (relatively greater weightage) when ElasticSearch 148 returns an ordered/ranked search result set.

Both the factoids search engine 143 and the embedding search engine 144 return passages to the orchestrator. The passages are potential answers to the question presented by the query. As stated above with respect to FIG. 2, the passages are paired with the question to form a plurality of question-passage pairs 114. Each of these question-passage pairs may be given an identification number. In some embodiments, the question-passage pairs may be ranked by relevancy. For example, the question-passage pairs may each be assigned a relevancy score based on similarity between the passage and the question.

Referring once again to FIG. 3, the orchestrator module 141 receives the question-passage pairs and provides them to the answer finder module 145, which is a re-ranker that selects the best passage(s) among the question-passage pairs to be presented as the answer to the query.

The answer finder module's main responsibility is, given a question and passage pair, to compute the probability of the passage being an answer to the question. The answer finder module 145 includes a BERT sequence binary classifier that was trained on question-passage pairs.

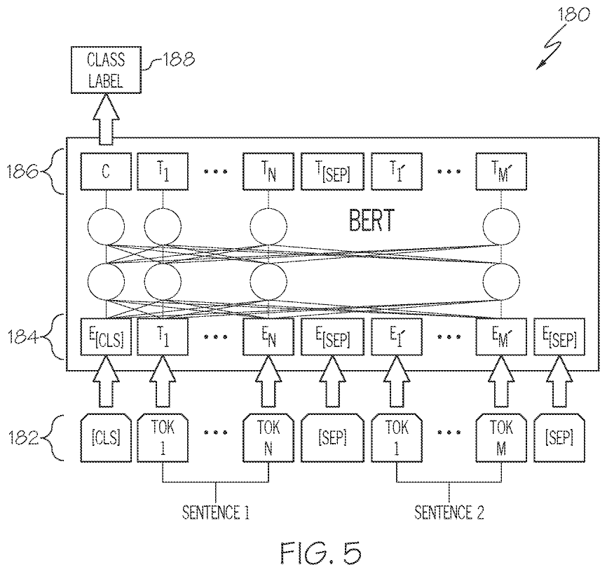

FIG. 5 schematically illustrates a BERT sequence binary classifier 180 of an answer finder module 145. Given an input text as a sequence of tokens X=(x0, x1, . . . , xn−1), BERT outputs sequences of contextual vectors 186. For passing a question and a passage as an input token sequence, question and passage tokens will be attached together. In addition to adding a [CLS] token as the first token and a [SEP] token as the final token, a [SEP] token will be inserted between the question and the passage. The BERT binary sequence classifier sends a vector representation of the first token of the sequence [CLS], Y=(y0, y1, . . . , ym−1), to a two-node dense layer to classify between two classes of “valid question answer” and “invalid question answer”. The output is logits Z=(z0, z1) (i.e., class label 188). The BERT classifier has multi headed attention layers. These attention layers cause the model to learn the relations among different tokens in different positions. With learning from enough data, the model can recognizes what a good “element-of” question and answer looks like.

The answer finder module is fine-tuned on Legal-BERT. An additional SoftMax layer is added to the classifier to provide the probability of the input question-passage membership to each class, P=softmax(Z). The Softmax function normalizes the output to a probability distribution over predicted output classes (“invalid” and “valid” question and answer pairs). The main output of Answer Finder is P1=softma(Z)[1] which is the answer finder module's prediction on how likely a question-passage pair is a good question-passage pair.

An open-source question-answer dataset was used as the training dataset. However, a domain-specific dataset may be utilized for training purposes. The inventors selected the Natural Questions (NQ) provided by Google as the training dataset because of the availability of the long answers, and also because the passages come from a retrieved document for a real user-issued question. The questions are not created based on the passages.

The NQ dataset contains 307,372 questions. There are approximately thirty passages for each question. Long answers were tagged as long answers, and the others were considered negative instances. A long answer could be a paragraph, a list, or a table. Short answers may also tagged in these passages if available. Focusing on the long contextual answer, just the questions that had long paragraph answers (107,089) were selected and used for training data.

For negative sampling, a two-step fine-tuning process was established. In the first round, a random negative passage was selected for each question. After fine-tuning the answer finder module on this data set, the answer finder module was run to produce the probability on all negative samples. Then, for each question the negative answer with the highest probability of being a good answer was selected as the negative sample. This way the model, after learning based on the random negative samples, will focus on learning from hair-splitting (harder to predict) negative samples. 1,450 legal questions with positive and negative passages also were added to the second dataset. This model was trained on Tesla K80 (12 GB GPU Memory) with these hyper parameters: learning_rate: 2e-5, max_seq_length: 512, num_train_epochs:3, do_lower_case: True, batch_size=8. After this set of experiments, it was found that using max_seq_length:128 does not significantly lower the metrics.

Referring once again to FIGS. 1-3, the answer finder module 145 returns one or more passages that are selected as the answers 124 to the query. These passages have the highest probability of being the answer to the query. The answer(s) is then displayed within the front-end application 135 on an electronic display device. In some embodiments, the answer may be enhanced by additional information provided by enrichment services 146. Additional information may include court treatment information (e.g., Shepard's information offered by LexisNexis, treatise information, and others).

In some embodiments, duplicative answers are filtered. Many times, cases may include the same passages, such as the same phrasing of a legal doctrine. The system may filter out the duplicative answers so that only one is displayed to the user. Alternatively, similar answers may be grouped and presented to the user.

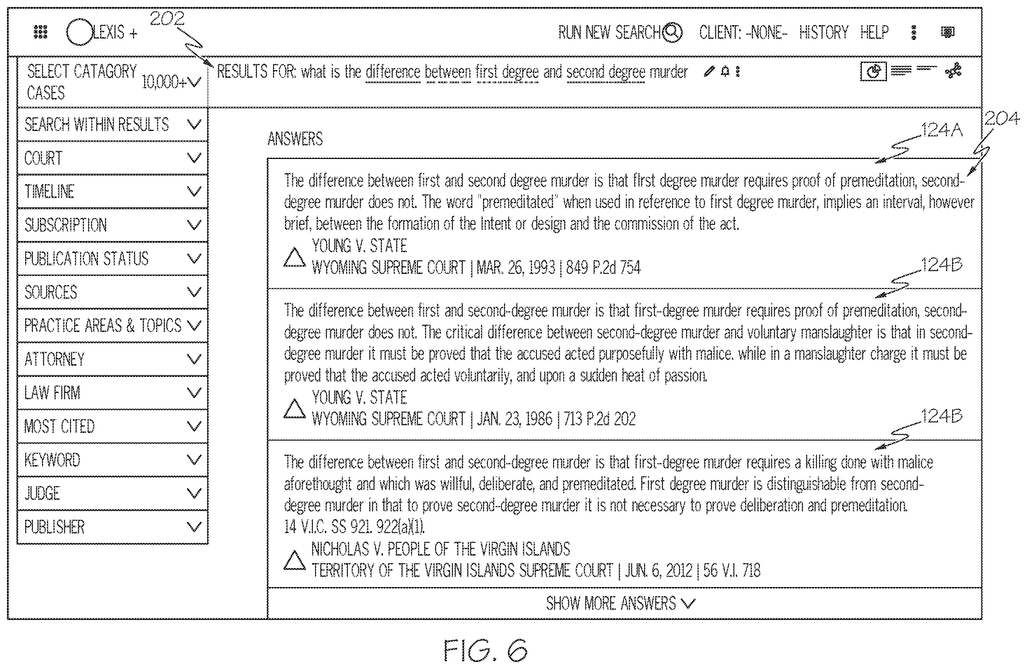

FIG. 6 illustrates a non-limiting example front-end application configured as a graphical user interface 200 for display on an electronic display. The graphical user interface 200 includes a text box 202 that provides a location for the user to enter a natural language query, which may be in the form of a natural language question. In the example of FIG. 6, the user has typed the natural language question “what is the difference between first degree and second degree murder” into the text box 202. The system first finds passages by searching the index 148 and ranking question-passage pairs by relevancy, and then determining the probability of each passage as being a correct answer to the question that is asked. The example graphical user interface 200 includes an answer region 204 where one or more of the best passages (i.e., those passages having the highest probability of being an answer determined by the answer finder module 145) are shown as answers. In the illustrated example, answers 124A, 124B, and 124C are shown in the answer region 204. It should be understood that any number of answers may be provided. For example, answers above a probability threshold may be available for viewing by the user in the answer region 204.

The index 148 also stores metadata regarding each of the passages that may then be displayed to the user in the graphical user interface 200. In the example of FIG. 6, metadata regarding the answer text, the jurisdiction of the case, the citation of the case, the case tile, and Shepard's signal for each passage are stored in the index, and then displayed in the graphical user interface 200. It should be understood that other types of information may be displayed depending on the application.

The user may select an answer to open the underlying document. For example, answer 124A is a case. By selecting the answer 124A, the case Young v. State is opened so that the text of the case is displayed in full. The user may then browse the case to perform the desired research.

Thus, the embodiments described herein provide the best possible answers to a natural language query, which both shortens the required research needed to obtain an answer, and instills confidence in the researcher that she has obtained the best possible answer(s) to the question.

### Example

To illustrate the use of the answer finder module in finding the best answers, an experiment was performed. Subject matter experts scored answers delivered using BM25 (more like this) with and without the use of the answer finder module, Legal Siamese BERT with and without the use of the answer finder module, and Legal GloVe with and without the user of the answer finder module.

The index, such as the index 148 shown in FIG. 3, comprised millions of passages defined by a combination of headnotes and RFCs. Legal Siamese BERT and Legal GloVe were trained to provide the semantical embeddings. Lexical information retrieval was performed by BM25 (more like this) and semantic information retrieval was performed by Legal Siamese BERT and Legal GloVe.

GloVe embeddings for the legal domain were built on 64 Gigabytes of legal text with 200 dimensional embeddings and run for epochs. The vocabulary size was 300,000. Once the embeddings of the legal text were built, embeddings for input questions and passages were built by taking the average of the embeddings of the corresponding words after removal of stop words.

The Legal Siamese BERT was trained to retrieve similar passages in the passage level contextual vector space. To create the training data for a sample set of headnotes, the most similar headnote (using BM25 (more like this)) was considered as a positive similar passage. Five random headnotes were added as negative instances. For training, a regression objective function with cosine loss was chosen. The input embedding was represented by mean pooling tokens as the sentence embedding, with the legal BERT base model (L=768) as the embedding model. We trained the model with train_batch_size=16, for 1 epoch setting the warmup steps to 94, calculated as: (0.10*number of training examples*num of epocs)/train batch size. Spearman and Pearson correlation upward trends were used as an indicator for convergence.

Regarding the answer finder process, the NQ dataset was used to train the answer finder module as described above.

A set of 100 questions was developed. 50% of the questions were historic real user queries and the other 50% were created by subject matter experts. The subject matter experts were asked to create different kinds of questions that could be useful for legal researchers including content, entity and analytic questions, although this solution just focuses on answering content questions.

The passages were queried with different methods including BM25 (more like this), Legal Siamese BERT, and Legal GloVe. The top three passages for each method was selected to be evaluated. For evaluating the answer finder module, the top thirty retrieved passages by BM25, Legal GloVe, and Legal Siamese BERT were fed to the answer finder and the top three passages based on the answer probability were selected for each retrieval method. These top three passages by different methods were passed to subject matter experts to be annotated to the scale of −1 to 3. The passages for each question were randomly ordered to prevent any bias toward any method.

The subject matter experts defined the rubric in Table 1 below for evaluating answers regarding each question. These ratings are more granular than the “valid” and “invalid” answers that the answer finder module is trained on.

TABLE 1
Rubric for evaluating answers

| Score | Criteria |
|---|---|
| −1 | so unrelated that it is not possible to make |
| | any connection to the question; it makes us |
| | look bad and would cause a user to lose |
| | patience with the system |
| 0 | off point; it does not provide an answer to |
| | the question and is not reasonably related |
| 1 | generally on the right topic but does not |
| | provide an answer to the question |
| 2 | a partial answer or provides some relevant |
| | guidance that does not directly answer |
| | the question |
| 3 | a good answer |

Table 2 below shows examples of retrieved passages and answers for a given question (“is an airline liable for its pilot's negligence?”) along with the labels provided by the subject matter experts. In this specific example, BM25 (more like this) picked a very long passage with multiple occurrences of ‘airline’, ‘pilot’, ‘liable’ and ‘negligence’ the passage is off-point but according to the evaluation of the subject matter experts. Legal GloVe and Legal Siamese BERT picked a short passage semantically similar to the question even though the word ‘pilot’ is not contained in the passage. The passage is on the right topic but doesn't answer the question. Answer Finder on BM25 (more like this) picked a passage that is a good answer. The passage has all elements and actors of the question and discusses in what condition the carrier (airline) is liable for a pilot's negligence. It is noted that this passage originally was at position 27 in the 30 top BM25 (more like this) retrieved passages as ranked by relevance, but the answer finder module promoted it to the top. Thus, this answer would not have been prominently displayed to the user without the use of the answer finder module.

TABLE 2
Samples of question and passaged (bm25_mlt: BM25 more-like-this,
L S BERT: Siamese Le− gal GloVe, AF: Answer Finder)

| passages for question: “is an airline | SME | |
|---|---|---|
| liable for its pilot's negligence” | label | method |
| A carrier would not be liable for an | 3 | AF on |
| error of judgment of the pilot, not | | bm25_mlt |
| constituting positive negligence on | | |
| his part in exercising such | | |
| judgment; but liability is incurred | | |
| if the pilot, by his negligent and | | |
| careless conduct, has created a | | |
| situation requiring the formation of | | |
| a judgment and then errs in the | | |
| exercise thereof. | | |
| It is true that a pilot and an air | 1 | AF on L S |
| traffic controller each owe a | | bert |
| duty of care to passengers in an | | |
| airplane, and negligence by the | | |
| pilot does not, in and of itself, | | |
| absolve the government of | | |
| liability. | | |
| The pilot bears final authority for | 1 | AF on L |
| aircraft operation and is to be held | | GloVe |
| to the highest degree of care. Air | | |
| traffic controllers can be held | | |
| liable if negligence on the part of | | |
| such persons has a causal | | |
| relationship to the happening of | | |
| the accident. | | |
| An airline corporation is not an | 1 | L GloVe, |
| insurer of the safety of its | | L S BERT |
| passengers. The liability of an | | |
| airline corporation must be | | |
| based on negligence. | | |
| Airline pilot who was accused of | 0 | bm25_mlt |
| raping flight attendant has no tort | | |
| claim against airline based upon its | | |
| alleged negligent investigation of | | |
| accusation, even if airline's | | |
| policy of investigating sexual | | |
| harassment complaints creates duty | | |
| to use due care in conducting | | |
| investigation, where violation of | | |
| such duty would give rise to | | |
| contract, not tort, claim; negligence | | |
| cannot provide basis for recovery of | | |
| damages for mental and emotional | | |
| suffering pled by pilot, negligence | | |
| cannot supply malice requirement for | | |
| pilot's defamation claim arising | | |
| from investigation, and there is | | |
| insufficient evidence to hold airline | | |
| liable for alleged defamatory | | |
| statements. . . . | | |

Although the scores of the subject matter experts have 5 levels, the subject matter experts usually consider ‘2’ and ‘3’ answers as acceptable answers and the others as unacceptable. By applying this mapping to the test set, the F1 measure and accuracy that is shown in Table 3 were calculated. Based on the Inter Rater Agreement (IRR) experiment between the subject matter experts, the estimated human accuracy is 89%.

TABLE 3
Metrics on Answer Finder Classifier

| model | F1 measure | accuracy |
|---|---|---|
| Answer Finder | 0.64 | 0.81 |

F1 measure and accuracy are proper metrics for a classifier. However, the use-case is showing three answers to the legal researcher's questions. DCG (Discounted Cumulative Gain), MRR (Mean Reciprocal Rank), and MAP (Mean Average Precision) are the well-established metrics that match the use-case. In addition to using the answer finder module as a re-ranker, the answer finder module probability may also be used to set a threshold to filter answers below the threshold and return fewer than 3 answers to the user, but instead of 0.5 which is a normal binary classifier threshold, other thresholds could be used to eliminate less likely answers and pass the others.

In Table 4, different experiment setups could be compared. Highlighting a clear winner is difficult because of a number of factors should be accounted like the user experiences, cost and potential growth. Some of the more promising rows have been highlighted in the table below. In the tables and graphs, when the answer finder module combined more than one retrieving method, thirty passages from each method was passed to answer finder module.

TABLE 4
DCG, MRR and MAP of the selected methods. (bm25_mlt: BM25 more-like-this,
Si L BERT: Siamese Legal BERT, L GloVe: Legal GloVe, AF: Answer Finder)

| | | average | | | | |
|---|---|---|---|---|---|---|
| | average | DCG@3 on | number of | | MRR@3 on | MAP@3 on |
| | DCG@3 | questions | silly | number of | questions | questions |
| method | on 100 | answered | answers | questions | answered | answered |
| bm25_mlt | 4.052 | 4.052 | 7 | 100 | 0.411 | 0.142 |
| Si L BERT | 3.386 | 3.386 | 2 | 100 | 0.326 | 0.123 |
| L GloVe | 2.855 | 2.855 | 7 | 100 | 0.285 | 0.114 |
| AF on bm25 | 5.464 | 5.464 | 7 | 100 | 0.493 | 0.246 |
| AF on Si L BERT | 4.862 | 4.862 | 0 | 100 | 0.416 | 0.222 |
| AF on L GloVe | 4.281 | 4.281 | 7 | 100 | 0.397 | 0.196 |
| AF on bm25 + Si L BERT | 5.605 | 5.605 | 5 | 100 | 0.483 | 0.259 |
| AF on bm25 + L GloVe | 5.502 | 5.502 | 8 | 100 | 0.481 | 0.257 |
| AF on bm25 + Si L | 5.611 | 5.611 | 6 | 100 | 0.5 | 0.256 |
| BERT + L GloVe | | | | | | |
| AF on bm25 + Si L BERT | 5.579 | 6.268 | 2 | 89 | 0.543 | 0.292 |
| with threshold 0.2 | | | | | | |

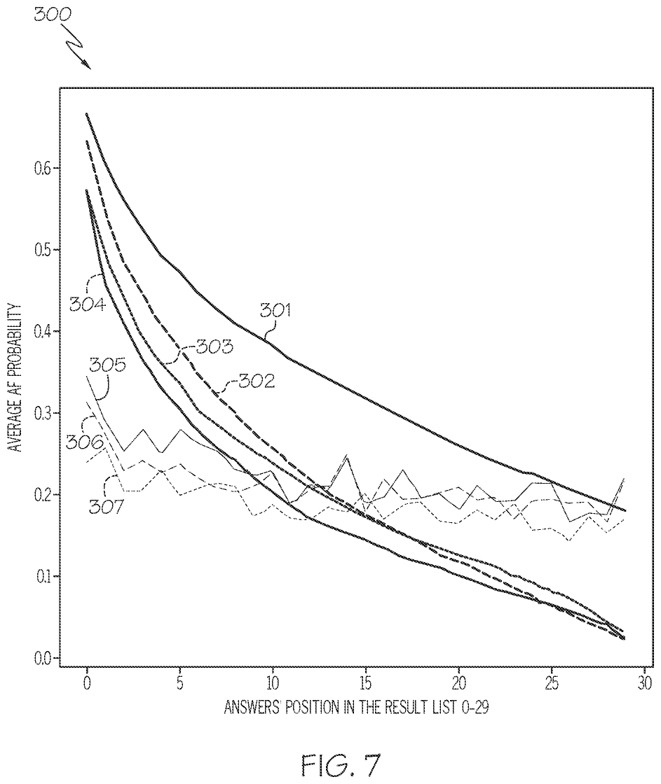

FIG. 7 is a graph showing the average probabilities of being a good answer with the different methods on one-hundred questions based on the position of the answer in the result list.

Curve 301 is the answer finder run on BM25+L S BERT, curve 302 is the answer finder run on bm25, curve 303 is the answer finder run on L S BERT, curve 304 is the answer finder run on Legal GloVe, curve 305 is bm25 (more like this), curve 306 is Legal Siamese BERT, and curve 307 is Legal GloVe. Using the answer finder module, the answers were sorted based on answer probability. Thus, answers with higher probability were promoted to the top of the list, and answers in the top of the list are more probable to be good answers to the user's question.

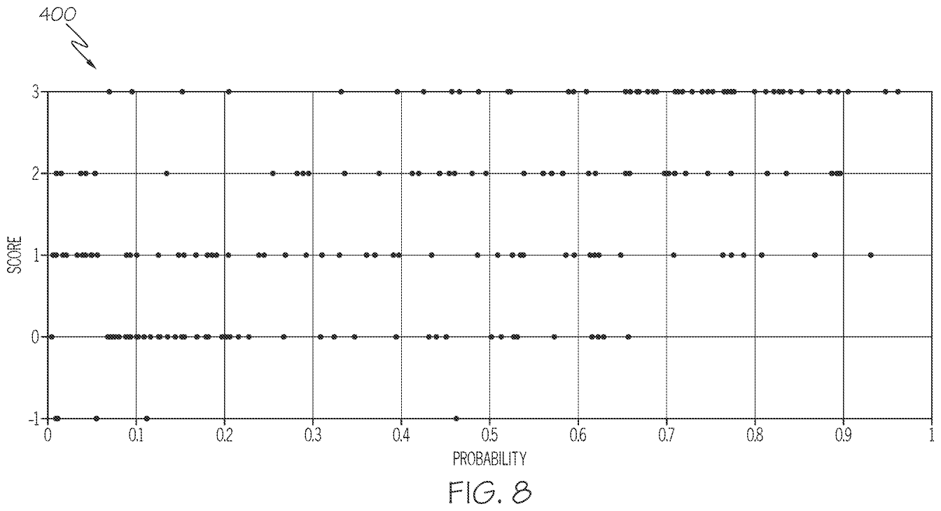

FIG. 8 is a graph showing acceptable correlation between the answer finder's probabilities and the subject matter expert's scores. The answer finder module can recognize ‘2’, ‘3’, and ‘-1’ answers with very high accuracy. It is also successful on recognizing most of ‘0’ answers but has difficulty on some of them and recognizing ‘1’ answers. In the experiments, the subject matter experts also had lower agreement on these scales. Training a “binary” classifier on mostly open source question-answers may be a source of this problem. Training using legal question-answers may improve the recognition of ‘0’ and ‘1’ answers.

### Example Hardware System

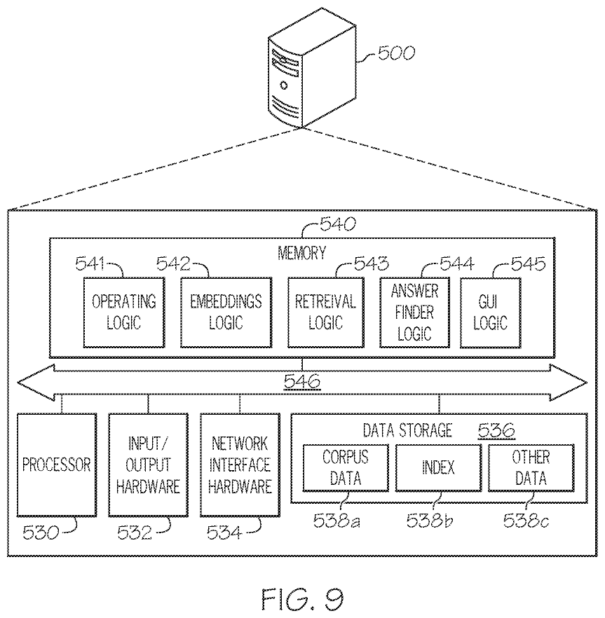

Embodiments of the present disclosure may be implemented by a computing device, and may be embodied as computer-readable instructions stored on a non-transitory memory device. FIG. 9 depicts an example computing device 500 configured to perform the functionalities described herein. The example computing device 500 provides a system for natural language query searching for answer retrieval, and/or a non-transitory computer usable medium having computer readable program code for natural language query searching for answer retrieval embodied as hardware, software, and/or firmware, according to embodiments shown and described herein. While in some embodiments, the computing device 500 may be configured as a general purpose computer with the requisite hardware, software, and/or firmware, in some embodiments, the computing device 500 may be configured as a special purpose computer designed specifically for performing the functionality described herein. It should be understood that the software, hardware, and/or firmware components depicted in FIG. 9 may also be provided in other computing devices external to the computing device 500 (e.g., data storage devices, remote server computing devices, and the like).

As also illustrated in FIG. 9, the computing device 500 (or other additional computing devices) may include a processor 530, input/output hardware 532, network interface hardware 534, a data storage component 536 (which may store corpus data 538A, index data 538B, and any other data 538C), and a non-transitory memory component 540. The memory component 540 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 540 may be configured to store operating logic 541, embeddings logic 542, retrieval logic 543, answer finder logic 544, and graphical user interface (GUI) logic 545 (each of which may be embodied as computer readable program code, firmware, or hardware, as an example). A local interface 546 is also included in FIG. 9 and may be implemented as a bus or other interface to facilitate communication among the components of the computing device 500.

The processor 530 may include any processing component configured to receive and execute computer readable code instructions (such as from the data storage component 536 and/or memory component 540). The input/output hardware 532 may include an electronic display device, keyboard, mouse, printer, camera, microphone, speaker, touch-screen, and/or other device for receiving, sending, and/or presenting data. The network interface hardware 534 may include any wired or wireless networking hardware, such as a modem, LAN port, wireless fidelity (Wi-Fi) card, WiMax card, mobile communications hardware, and/or other hardware for communicating with other networks and/or devices, such as to receive the corpus data 538A from various sources, for example.

It should be understood that the data storage component 536 may reside local to and/or remote from the computing device 500, and may be configured to store one or more pieces of data for access by the computing device 500 and/or other components. As illustrated in FIG. 9, the data storage component 536 may include corpus data 538A including documents from which passages are extracted (e.g., legal cases, opinions, statutes, law review articles, and the like). The data storage component 536 may also include index data 538B, which may include the passages extracted from the corpus data 538A as well as document metadata and embeddings. Other data 538C to perform the functionalities described herein may also be stored in the data storage component 536 (e.g., cached data, other embeddings, enrichment services data (e.g., Shepard's data)).

Included in the memory component 540 may be the operating logic 541, the embeddings logic 542, the retrieval logic 543, the answer finder logic 544, and the GUI logic 545. The operating logic 541 may include an operating system and/or other software for managing components of the computing device 500. Similarly, the retrieval logic 542 may reside in the memory component 540, and may be configured to search. The graphical user interface logic 544 may be configured to generate the graphical user interfaces described herein to view optimal answers to a natural language query. The embeddings logic 542 is configured to generate vectors of passage content and queries according to one or more embedding techniques. The embeddings logic 542 may be local to the computing device 500 and/or provided by a remote embeddings service. The retrieval logic 543 is configured to search the passages of the index data 538B with respect to a query entered by the user. Any number of query types may be provided by the retrieval logic (e.g., BM25, BM25 (more like this), word2vec, BERT, GloVe, and the like). The retrieval logic returns passages relevant to the query and, in some embodiments, generates question-passage pairs that are then ranked by relevancy. The answer finder logic 544 includes the answer finder module and receives the relevant question-passage pairs from the retrieval logic 542. The answer finder logic 544 is configured to find the best answers to the query by determining a probability that each passage of the question-passage pairs is a correct answer. Passage(s) of the question-passage pairs having the greatest probability are selected as the answer(s) to the query. The GUI logic 545 is configured to generated for display on an electronic display device a front-end application for a user to enter a query and also display the answers generated by the answer finder logic 544.

It should now be understood that embodiments of the present disclosure are directed to open domain questioning methods and systems that find and display one or more optimum answers to a user query. An information retrieval process is used to initially retrieve passages that potentially answer the question. Some or all of these passages are then provided to an answer finder module that re-ranks the passages based on the probability of each passaging being a correct answer to the natural language query. The answer finder significantly reduces the amount of time that a user searches for an answer to her question, and also reduces the amount of computing time and power because fewer queries need to be submitted for the user to find the correct answer to the question.

The systems and methods described herein are not limited to the legal domain, and may be adapted to any type of content, either static or dynamic, without adding more complexity to the architecture. Embodiments further provide for a combination of lexical and semantic searches across many different datasets (e.g., case law, statutes, treatises, etc.). Thus, less processing resources and time are needed to provide on-point answers to questions over traditional searching methods.

It will be apparent to those skilled in the art that various modifications and variations can be made without departing from the spirit or scope of the embodiments described herein. Since modifications, combinations, sub-combinations and variations of the disclosed embodiments incorporating the spirit and substance of the embodiments described herein may occur to persons skilled in the art, the embodiments described herein should be construed to include everything within the scope of the appended claims and their equivalents.

What is claimed is:

1. A method of providing answers to a query, the method comprising:
retrieving, by a computing device, a plurality of passages relevant to a search query;
generating a plurality of question-passage pairs, wherein each question-passage pair includes the search query and an individual passage of the plurality of passages;
determining, using a computer model, a probability that a passage of each question-passage pair of at least some of the plurality of question-passage pairs is an answer to a question posed by the search query; and
displaying, on an electronic display, a selected passage of a question-passage pair having a highest probability that the passage is the answer to the question posed by the search query.

2. The method of claim 1, further comprising:
ranking the plurality of passages based on a relevancy score prior to determining the probability; and
re-ranking the plurality of question-passage pairs based on the probability for each question-passage pair.

3. The method of claim 1, wherein the passages comprise one or more of headnotes and reasons for citing.

4. The method of claim 1, wherein the retrieving is performed by one or more lexical retrieval processes and one or more semantic retrieval processes.

5. The method of claim 4, wherein the one or more lexical retrieval processes comprises BM25.

6. The method of claim 5, further comprising embedding the plurality of passages and the search query with semantical embeddings by one or more semantical embedding processes.

7. The method of claim 6, wherein the one or more semantical embedding processes comprises word2vec, GloVe and a bidirectional encoder representations from transformers (BERT), and the one or more semantic retrieval processes query the semantical embeddings using a vector of the search query.

8. The method of claim 1, wherein the computer model comprises a BERT sequence binary classifier.

9. The method of claim 8, wherein the BERT sequence binary classifier is trained by:
providing as input a plurality of training question-passage pairs;
selecting a random negative passage for each question in a first training round;
for each negative sample, determining the probability that the negative sample is an answer an individual question of the plurality of training question-passage pairs; and
selecting, for each question, a negative passage with a highest probability in a second training round.

10. The method of claim 8, wherein the computer model further comprises a SoftMax layer that determines the probability based at least in part on an output of the BERT sequence binary classifier.

11. A system for providing answers to a query, the system comprising:
one or more processors; and
a non-transitory computer-readable medium storing computer-readable instructions that, when executed by the one or more processors, cause the one or more processors to:
retrieve a plurality of passages relevant to a search query;
generate a plurality of question-passage pairs, wherein each question-passage pair includes the search query and an individual passage of the plurality of passages;
determine, using a computer model, a probability that a passage of each question-passage pair of at least some of the plurality of question-passage pairs is an answer to a question posed by the search query; and
display, on an electronic display, a selected passage of a question-passage pair having a highest probability that the passage is the answer to the question posed by the search query.

12. The system of claim 11, wherein the computer-readable instructions further cause the one or more processors to:
rank the plurality of passages based on a relevancy score prior to determining the probability; and
re-rank the plurality of question-passage pairs based on the probability for each question-passage pair.

13. The system of claim 11, wherein the passages comprise one or more of headnotes and reasons for citing.

14. The system of claim 11, wherein the retrieving is performed by one or more lexical retrieval processes and one or more semantic retrieval processes.

15. The system of claim 14, wherein the one or more lexical retrieval processes comprises BM25.

16. The system of claim 15, wherein the computer-readable instructions further cause the one or more processors to embed the plurality of passages and the search query with semantical embeddings by one or more semantical embedding processes.

17. The system of claim 16, wherein the one or more semantical embedding processes comprises word2vec, GloVe and a bidirectional encoder representations from transformers (BERT), and the one or more semantic retrieval processes query the semantical embeddings using a vector of the search query.

18. The system of claim 11, wherein the computer model comprises a BERT sequence binary classifier.

19. The system of claim 18, wherein the BERT sequence binary classifier is trained by:
providing as input a plurality of training question-passage pairs;
selecting a random negative passage for each question in a first training round;
for each negative sample, determining the probability that the negative sample is an answer an individual question of the plurality of training question-passage pairs; and
selecting, for each question, a negative passage with a highest probability in a second training round.

20. The system of claim 19, wherein the computer model further comprises a SoftMax layer that determines the probability based on an output of the BERT sequence binary classifier.
